(19) United States
(12) Patent Application Publication
(10) Pub. No.: US 2018/0220391 A1
(43) Pub. Date: Aug. 2, 2018

(54) NETWORK REGISTRATION METHOD AND MOBILE DEVICE

(71) Applicant: YULONG COMPUTER TELECOMMUNICATION SCIENTIFIC (SHENZHEN) CO., LTD., Shenzhen (CN)

(72) Inventors: JI-SHENG HAN, Shenzhen (CN); CHAO-LIN REN, Shenzhen (CN)

(21) Appl. No.: 15/939,326

(22) Filed: Mar. 29, 2018

Related U.S. Application Data
(63) Continuation-in-part of application No. PCT/CN2016/097038, filed on Aug. 27, 2016.

(30) Foreign Application Priority Data
Sep. 29, 2015 (CN) 201510632667.8

(51) Int. Cl. H04W 60/04; H04W 48/18; H04W 48/16

(52) U.S. Cl. CPC H04W 60/04; H04W 36/14; H04W 48/16; H04W 48/18

(57) ABSTRACT

A network registration method is described. The method including: reading a RPLMN recorded by a mobile device, when the mobile device is powered on, and obtaining a PLMN of a current candidate cell through network scanning; determining whether the mobile device is initially powered on in a roaming location, according to the RPLMN recorded by the mobile device and the PLMN of the current candidate cell; carrying out a network registration using the PLMN of the current candidate cell, when it is determined that the mobile device is initially powered on in the roaming location. A mobile device is also disclosed. The methods and devices described can simplify network registration when the mobile device is in the roaming location when the mobile device is initially powered. Thus, the network registration can be achieved more quickly.

### CROSS-REFERENCE TO RELATED APPLICATIONS

The present disclosure claims a priority of a Chinese patent application, which is filed to Chinese patent office on Sep. 29, 2015, named “a network registration method and a mobile device,” and numbered 201510632667.8. All contents of Chinese patent application are described in the present disclosure by reference.

### FIELD

The invention relates to a technical field of network communication, in particular to a network registration method and a mobile device.

### BACKGROUND

A mobile device needs to be registered in the public land mobile network (PLMN), when the mobile device is powered on. The PLMN is a network established and managed by a government or an operator approved by the government, for the purpose of providing land mobile communication services for the public. The network must be interconnected with a public switched telephone network (PSTN), to form a communication network of a whole area or a nationality. The PLMN includes a mobile country code (MCC) and a mobile network code (MNC).

In the prior art, when a mobile device is initially powered on in a roaming location, firstly, a registered PLMN (RPLMN, a PLMN registered before powered-off or off-network in the last-time), which is recorded by the mobile device, is obtained. Then, a network format and a scanning frequency are determined. After that, the PLMN of a candidate cell is obtained through network scanning. Due to the mobile device being powered on in a roaming location, the RPLMN recorded by the mobile device does not match with the PLMN of the candidate cell. Network registration fails under the network format. Therefore, it is necessary to reselect and use the RPLMN to perform network registration under a next network format. Network registration will be still failed after being carried out using the RPLMN under all network formats. At the end, other modes are selected for the network registration. Accordingly, the network registration costs long time.

Thus, there is room for improvement within the art.

### BRIEF DESCRIPTION OF THE DRAWINGS

In order to illustrate the technical solutions of the embodiments of the present disclosure more clearly, the accompanying drawings required in the description of the embodiments are introduced briefly in the following. Apparently, the accompanying drawings in the following description only are some embodiments of the present disclosure. It will be understood by those skilled in the art, other drawings can be obtained without creative efforts according to the accompanying drawings.

FIG. 1 is a flowchart of a first embodiment of a network registration method according to the present disclosure.

FIG. 2 is a flowchart of a second embodiment of a network registration method according to the present disclosure.

FIG. 3 is a schematic structural diagram of a mobile device according to an embodiment of the present disclosure.

FIG. 4 is a schematic structural diagram of an information acquisition module in the mobile device according to an embodiment of the present disclosure.

FIG. 5 is a schematic structural diagram of a network registration module in the mobile device according to an embodiment of the present disclosure.

FIG. 6 is a schematic structural diagram of another mobile device according to an embodiment of the present disclosure.

### DETAILED DESCRIPTION

The technical solutions in the embodiments of the present disclosure will be described clearly and completely with reference to the accompanying drawings in the embodiments of the present disclosure. Apparently, the described embodiments are only a part of the embodiments of the present disclosure, not all. Based on the embodiments of the present disclosure, other embodiments, which can be obtained by persons of ordinary skill in the art without creative efforts, also belong to the protection scope of the present disclosure.

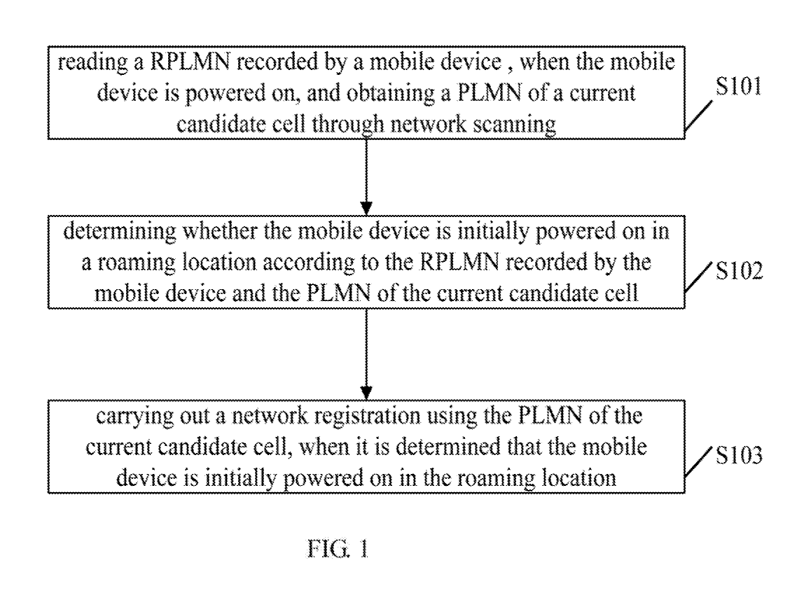

FIG. 1 is a flowchart of a first embodiment of a network registration method according to the present disclosure. As shown in the figure, the method in the present embodiment may include any of the following steps.

S101: a RPLMN recorded by a mobile device is read when the mobile device is powered on, and a PLMN of a current candidate cell is obtained through network scanning.

In an embodiment, when the mobile device is powered off, a PLMN registered before the powering off or off-network, or a frequency point of a cell where the mobile device is located, needs to be recorded. The mobile device can use the PLMN registered before the powering off or off-network (RPLMN) to carry out a network registration, when the mobile device is powered on the next time. Therefore, when the mobile device is powered on, the RPLMN recorded by the mobile device can be read, and the frequency point of the cell corresponding to the RPLMN can also be read.

Additionally, a network format registered by the mobile device can be acquired. A system message of the current candidate cell is obtained by network scanning on a plurality of cells, according to the RPLMN recorded by the mobile device and the network format registered by the mobile device. A PLMN of the current candidate cell is acquired from the system message obtained from the network scanning. For example, a plurality of network formats (GSM, WCMDA, CDMA, and the like) exists in the mobile device. One network format needs to be selected from the plurality of network formats. After the network format and the RPLMN are determined, a logic layer of the mobile device sends a network scanning request to a physical layer of the mobile device. The physical layer performs network scanning according to the network format and the RPLMN, to obtain a system message of the current candidate cell and acquire the PLMN of the current candidate cell from the system message.

Further, a scanning frequency point preset by the mobile device can be acquired first. A signal quality of each cell in plurality of cells is obtained by performing network scanning on the plurality of cells according to the preset scanning frequency point. A cell with the best signal quality is selected in the plurality of cells as the current candidate cell, and the system message of the current candidate cell is acquired. For example, the network scanning can be carried out on the frequency points of the cells corresponding to the RPLMN, or be carried out on all the frequency points supported by the mobile device. Multiple scanning frequency points are preset in mobile device. A cell with the best signal quality can be obtained using each scanning frequency point for network scanning. Thus, PLMNs of a plurality of current candidate cells can be obtained through the network scanning. A PLMN list can be established for the PLMNs of the plurality of current candidate cells, and a priority of each current candidate cell is set.

S102: whether the mobile device is initially powered on in a roaming location is determined according to the RPLMN recorded by the mobile device and the PLMN of the current candidate cell.

In an embodiment, the RPLMN recorded by the mobile device includes a first mobile country code, and the PLMN of the current candidate cell includes a second mobile country code. It is determined that whether the first mobile country code is the same as the second mobile country code. A determination that the mobile device is initially powered on in a roaming location is made if the first mobile country code is different from the second mobile country code. A determination that the mobile device is not initially powered on in a roaming location is made if the first mobile country code is the same as the second mobile country code. The PLMN includes a mobile country code (MCC) and a mobile network code (MNC).

The mobile country codes can be identical in the same country. The embodiment of the present disclosure is suitable to determine whether the mobile device is initially powered on in a foreign roaming location. If the first mobile country code is different from the second mobile country code, it can be determined that the mobile device enters into a foreign roaming location.

S103: a network registration is carried out using the PLMN of the current candidate cell, when it is determined that the mobile device is initially powered on in the roaming location.

In an embodiment, a signal quality of each candidate cell in the plurality of candidate cells can be acquired. The cell with the highest priority in the candidate cells is determined according to the signal quality of each candidate cell. A network registration request is initiated to a cell with the highest priority using the PLMN with the highest priority, enables the cell with the highest priority to provide network services to the mobile device. The signal quality can be a signal intensity of a cell, an anti-interference capability, and the like.

Optionally, when it is determined that the mobile device is initially powered on in a roaming location, the usage of the RPLMN to perform network registration needs to be terminated. The network registration according to the priority of each candidate cell preset in the PLMN list is carried out. The mobile device enters a normal service state when the network registration is successful. Additionally, when the network registration using the PLMN of the candidate cell with the highest priority fails, the PLMN of the candidate cells with the next priority is used. S102 and S103 are repeated using a next network format, when the network registrations using the PLMNs of all the candidate cells are failure.

The embodiment of the present disclosure firstly reads a RPLMN recorded by a mobile device, when the mobile device is powered on, and obtains a PLMN of a current candidate cell through network scanning; and then, determines whether the mobile device is initially powered on in a roaming location, according to the RPLMN recorded and the PLMN of the current candidate cell; finally, carries out a network registration using the PLMN of the current candidate cell, when it is determined that the mobile device is initially powered on in a roaming location. The present disclosure can simplify steps of the network registration in a roaming location, when the mobile device is initially powered on in the roaming location. Thus, a speed of the network registration can be increased.

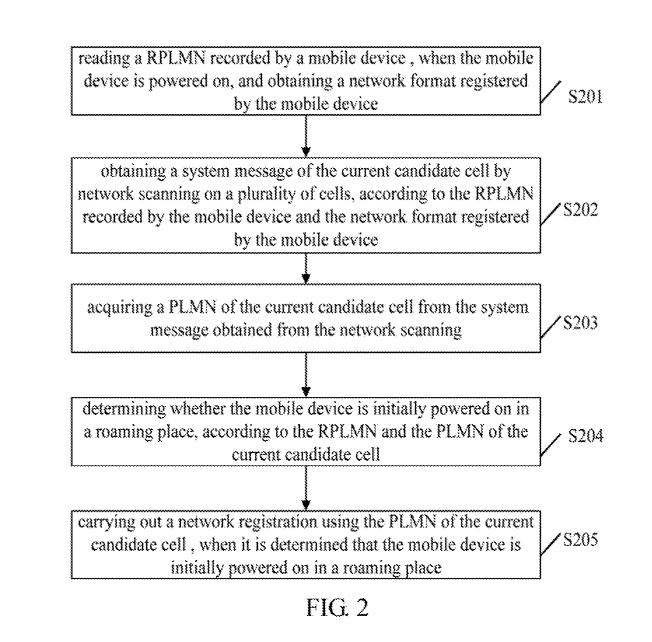

FIG. 2 is a flowchart of a second embodiment of a network registration method according to the present disclosure. As shown in the figure, the method in the embodiment may include any of the following steps.

S201: a RPLMN recorded by a mobile device is read, when the mobile device is powered on, and a network format registered by the mobile device is obtained.

In an embodiment, when the mobile device is powered off, a PLMN registered before the powering off or off-network, or a frequency point of a cell where the mobile device is located, needs to be recorded. The mobile device can use the PLMN registered before the powering off or off-network (RPLMN) to carry out a network registration, when the mobile device is powered on the next time. Therefore, when the mobile device is powered on, the RPLMN recorded by the mobile device can be read, and the frequency point of the cell corresponding to the RPLMN can also be read. A plurality of network formats (GSM, WCMDA, CDMA, and the like) exists in the mobile device, thus, a network format needs to be selected from the plurality of network formats.

S202, a system message of the current candidate cell is obtained by network scanning on a plurality of cells, according to the RPLMN recorded by the mobile device and the network format registered by the mobile device.

For example, after the network format and the RPLMN are determined, a logic layer of the mobile device sends network scanning request to a physical layer of the mobile device. The physical layer performs network scanning according to the network format and the RPLMN, to obtain a system message of the current candidate cell.

Optionally, a scanning frequency point preset by the mobile device can be acquired first. A signal quality of each cell in plurality of cells is obtained by performing network scanning on the plurality of cells according to the preset scanning frequency point. A cell with the best signal quality is selected in the plurality of cells as the current candidate cell, and the system message of the current candidate cell is acquired. It may be understood that, the network scanning can be carried out on the frequency points of the cells corresponding to the RPLMN, or be carried out on all the frequency points supported by the mobile device. Multiple scanning frequency points are preset in mobile device. A cell with the best signal quality can be obtained using each scanning frequency point for network scanning. Thus, PLMNs of a plurality of current candidate cells can be obtained through the network scanning. A PLMN list can be established for the PLMNs of the plurality of current candidate cells, and a priority of each current candidate cell is set.

S203: a PLMN of the current candidate cell is acquired from the system message obtained from the network scanning.

S204: whether the mobile device is initially powered on in a roaming location is determined, according to the RPLMN and the PLMN of the current candidate cell.

The RPLMN recorded by the mobile device includes a first mobile country code, and the PLMN of the current candidate cell includes a second mobile country code. It is determined that whether the first mobile country code is the same as the second mobile country code. A determination that the mobile device is initially powered on in a roaming location is made if the first mobile country code is different from the second mobile country code. A determination that the mobile device is not initially powered on in a roaming location is made if the first mobile country code is the same as the second mobile country code. The PLMN includes a mobile country code (MCC) and a mobile network code (MNC).

The mobile country codes can be identical in the same country. An application range of the embodiment of the present disclosure is suitable to determine whether the mobile device is initially powered on in a foreign roaming location. If the first mobile country code is different from the second mobile country code, it can be determined that the mobile device enters into a foreign roaming location.

S205: a network registration using the PLMN of the current candidate cell is carried out, when it is determined that the mobile device is initially powered on in a roaming location.

In an embodiment, a signal quality of each candidate cell in the plurality of candidate cells can be acquired. The cell with the highest priority in the candidate cells is determined according to the signal quality of each candidate cell. A network registration request is initiated to a cell with the highest priority, using the PLMN with the highest priority, enables the cell with the highest priority to provide network services to the mobile device. The signal quality can be a signal intensity of a cell, an anti-interference capability, and the like.

Optionally, when it is determined that the mobile device is initially powered on in a roaming location, the usage of the RPLMN to perform network registration needs to be terminated. The network registration according to the priority of each candidate cell preset in the PLMN list is carried out. The mobile device enters a normal service state when the network registration is successful. Additionally, when the network registration using the PLMN of the candidate cell with the highest priority fails, the PLMN of the candidate cells with the next priority is used. S102 and S103 are repeated using a next network format, when the network registrations using the PLMNs of each of the candidate cells is failure.

The embodiment of the present disclosure firstly reads a RPLMN recorded by a mobile device, when the mobile device is powered on, and obtains a PLMN of a current candidate cell through network scanning. Then, it is determined whether the mobile device is initially powered on in a roaming location, according to the RPLMN recorded and the PLMN of the current candidate cell. Finally, a network registration using the PLMN of the current candidate cell, is carried out when it is determined that the mobile device is initially powered on in a roaming location. The present disclosure can simplify steps of the network registration in a roaming location, when the mobile device is initially powered on in the roaming location. Thus, a speed of the network registration can be increased.

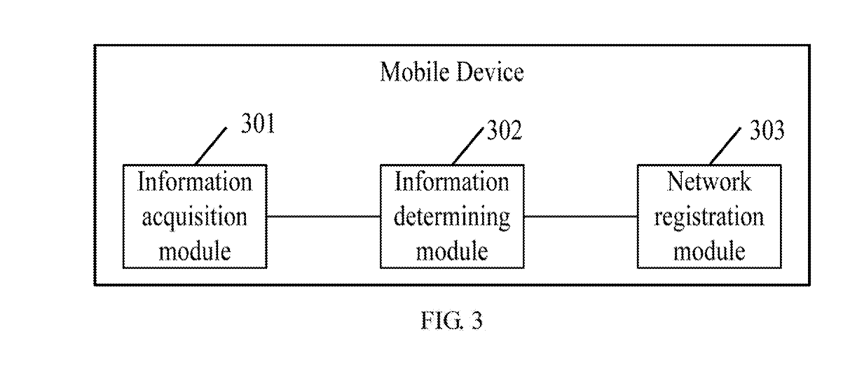

FIG. 3 is a schematic structural diagram of a mobile device according to an embodiment of the present disclosure. As shown in FIG. 3, the mobile device in the embodiment of the present disclosure may include any of the following modules.

An information acquisition module 301 is configured to read a RPLMN recorded by a mobile device, when the mobile device is powered on, and obtain a PLMN of a current candidate cell through network scanning.

In an embodiment, when the mobile device is powered off, a PLMN registered before the powering off or off-network, or a frequency point of a cell where the mobile device is located, needs to be recorded. The mobile device can use the PLMN registered before the powering off or off-network (RPLMN) to carry out a network registration, when the mobile device is powered on the next time. Therefore, when the mobile device is powered on, the RPLMN recorded by the mobile device can be read, and the frequency point of the cell corresponding to the RPLMN can also be read.

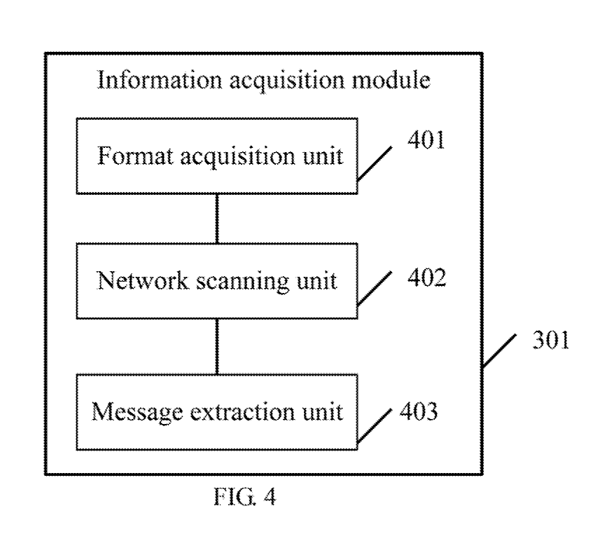

FIG. 4 shows the information acquisition module 301 may further include any of the following units.

A format acquisition unit 401 is configured to acquire a network format registered by the mobile device.

A network scanning unit 402 is configured to obtain a system message of the current candidate cell by network scanning on a plurality of cells, according to the RPLMN recorded by the mobile device and the network format registered by the mobile device.

In an embodiment, a scanning frequency point preset by the mobile device can be acquired first. A signal quality of each cell in plurality of cells is obtained by performing network scanning on the plurality of cells according to the preset scanning frequency point. A cell with the best signal quality is selected in the plurality of cells as the current candidate cell, and the system message of the current candidate cell is acquired. For example, the network scanning can be carried out on the frequency points of the cells corresponding to the RPLMN, or be carried out on all the frequency points supported by the mobile device. Multiple scanning frequency points are preset in mobile device. A cell with the best signal quality can be obtained using each scanning frequency point for network scanning. Thus, PLMNs of a plurality of current candidate cells can be obtained through the network scanning. A PLMN list can be established for the PLMNs of the plurality of current candidate cells, and a priority of each current candidate cell is set.

A message extraction unit 403 is configured to acquire a PLMN of the current candidate cell from the system message obtained from the network scanning.

An information determining module 302 is configured to determine whether the mobile device is initially powered on in a roaming location, according to the RPLMN recorded and the PLMN of the current candidate cell.

In an embodiment, the RPLMN recorded by the mobile device includes a first mobile country code, and the PLMN of the current candidate cell includes a second mobile country code. It is determined that whether the first mobile country code is the same as the second mobile country code. A determination that the mobile device is initially powered on in a roaming location is made if the first mobile country code is different from the second mobile country code. A determination that the mobile device is not initially powered on in a roaming location is made if the first mobile country code is the same as the second mobile country code. The PLMN includes a mobile country code (MCC) and a mobile network code (MNC).

In an embodiment, the RPLMN recorded by the mobile device includes a first mobile country code, and the PLMN of the current candidate cell includes a second mobile country code. It is determined that whether the first mobile country code is the same as the second mobile country code. A determination that the mobile device is initially powered on in a roaming location is made, if the first mobile country code is different from the second mobile country code. A determination that the mobile device is not initially powered on in a roaming location is made, if the first mobile country code is the same as the second mobile country code. The PLMN includes a mobile country code (MCC) and a mobile network code (MNC).

A network registration module 303 is configured to carry out a network registration using the PLMN of the current candidate cell, when it is determined that the mobile device is initially powered on in a roaming location.

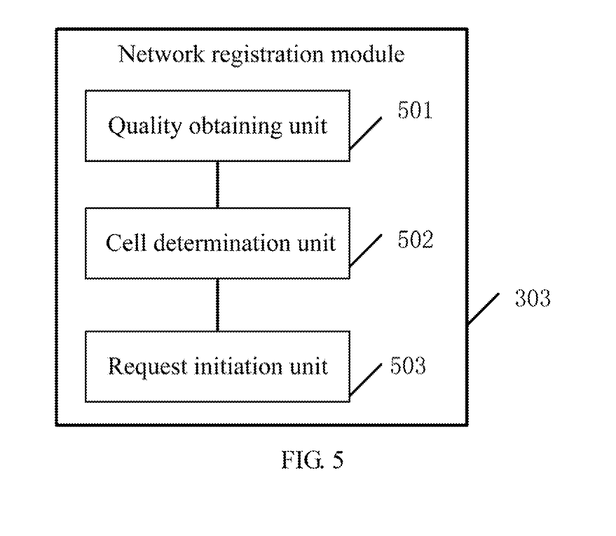

FIG. 5 shows the network registration module 303 may further include any of the following.

A quality obtaining unit 501 is configured to acquire a signal quality of each candidate cell in the plurality of candidate cells. The signal quality can be a signal intensity of a cell, an anti-interference capability, or any other indicator of signal quality.

A cell determination unit 502 is configured to determine the cell with the highest priority in the candidate cells according to the signal quality of each candidate cell.

A request initiation unit 503 is configured to initiate a network registration request to a cell with the highest priority, using the PLMN with the highest priority, enables the cell with the highest priority to provide network services to the mobile device.

Optionally, when it is determined that the mobile device is initially powered on in a roaming location, the usage of the RPLMN to perform network registration needs to be terminated. The network registration according to the priority of each candidate cell preset in the PLMN list is carried out. The mobile device enters a normal service state when the network registration is successful. Additionally, when the network registration using the PLMN of the candidate cell with the highest priority fails, the PLMN of the candidate cells with the next priority is used. The above modules can be implemented again using a next network format, when the network registration using the PLMNs of each of the candidate cells is failure.

The embodiment of the present disclosure firstly reads a RPLMN recorded by a mobile device, when the mobile device is powered on, and obtains a PLMN of a current candidate cell through network scanning. Then, it is determined whether the mobile device is initially powered on in a roaming location, according to the RPLMN recorded and the PLMN of the current candidate cell. Finally, a network registration using the PLMN of the current candidate cell is carried out, when it is determined that the mobile device is initially powered on in a roaming location. The present disclosure can simplify steps of the network registration in a roaming location, when the mobile device is initially powered on in the roaming location. Thus, a speed of the network registration can be increased.

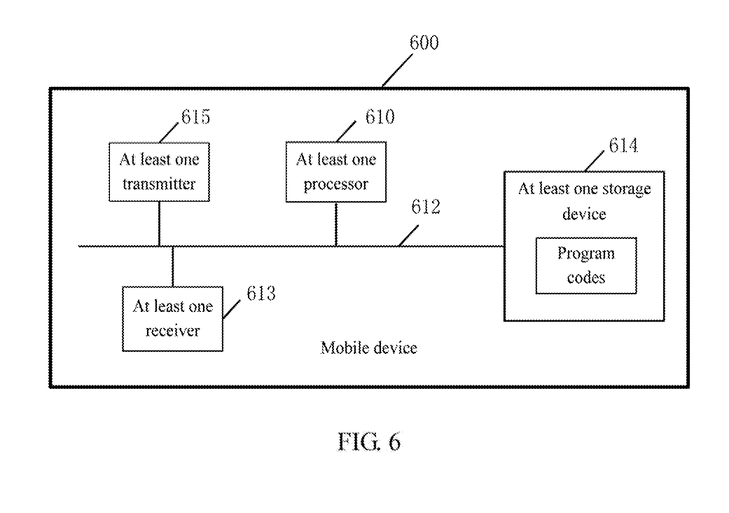

FIG. 6 is a schematic structural diagram of another mobile device according to an embodiment of the present disclosure.

The mobile device 600 in the embodiments of the present disclosure can be any type of electronic device, such as a smart phone, a tablet computer, a handheld computer and mobile internet equipment, a personal digital assistant, a media player, an intelligent television, an intelligent watch, intelligent glasses, an intelligent bracelet, or any other electronic device that operates with access to a network. As shown in FIG. 6, the mobile device 600 in the embodiment of the present disclosure includes at least one processor 610, such as a CPU, at least one receiver 613, at least one storage device 614, at least one transmitter 615, and at least one communication bus 612. The communication bus 612 realizes data communication between these components. The receiver 613 and the transmitter 615 may be wired transmission ports, and can also be wireless equipment, such as an antenna device, which is used for performing data communication with other equipments. The storage device 614 can be a high-speed RAM memory or a non-volatile memory, such as, at least one magnetic disk storage.

The processor 610 can execute an operating system of the mobile device 600 and various installed application programs, program codes, and the like. For example, each module and unit, including the information acquisition module 301, and the information determination module 302, the network registration module 303, the format acquisition unit 401, the network scanning unit 402, the message extraction unit 403, the quality obtaining unit 501, the cell determination unit 502, the request initiation unit 503, and the like.

The storage device 614 stores program codes. The processor 610 can invoke the program codes stored in the storage device 614 through the communication bus 612, to execute related functions. For example, each of the modules and units described in FIG. 3, FIG. 4, and FIG. 5 (e.g., the information acquisition module 301, the information determination module 302 and the network registration module 303, the network scanning unit 402, the message extraction unit 403, the quality obtaining unit 501, the cell determination unit 502, the request initiation unit 503, and the like) is a program code stored in the storage device 614 and is executed by the processor 610, so that the function of each module or unit can be implemented to realize the network registration processing.

In one embodiment of the present disclosure, the storage device 614 stores a plurality of instructions. The instructions are executed by the processor 610 to implement a network registration method. For example, when the mobile device 600 is powered on, the processor 610 reads a RPLMN recorded by a mobile device, and obtains a network format registered by the mobile device 600. The processor 610 determines whether the mobile device 600 is initially powered on in a roaming location, according to the RPLMN recorded and the PLMN of the current candidate cell. The processor 610 carries out a network registration using the PLMN of the current candidate cell, when it is determined that the mobile device is initially powered on in a roaming location.

In another embodiment, the processor 610 acquires a network format registered by the mobile device 600. The processor 610 obtains a system message of the current candidate cell by network scanning on a plurality of cells, according to the RPLMN recorded by the mobile device 600 and the network format registered by the mobile device 600. The processor 610 acquires a PLMN of the current candidate cell from the system message obtained from the network scanning.

In another embodiment, the processor 610 acquires a scanning frequency point preset by the mobile device 600. The processor 610 obtains a signal quality of each cell in plurality of cells by performing network scanning on the plurality of cells according to the preset scanning frequency point. The processor 610 selects a cell with the best signal quality in the plurality of cells as the current candidate cell, and acquires the system message of the current candidate cell.

In another embodiment, the RPLMN recorded by the mobile device includes a first mobile country code, and the PLMN of the current candidate cell includes a second mobile country code. The processor 610 determines whether the first mobile country code is the same as the second mobile country code. The processor 610 makes a determination that the mobile device is initially powered on in a roaming location being made if the first mobile country code is different from the second mobile country code.

In another embodiment, the current candidate cell includes a plurality of candidate cells. The processor acquires a signal quality of each candidate cell in the plurality of candidate cells; selects a cell with the highest priority in the plurality of candidate cells according to the signal quality of each candidate cell; and initiates a network registration request to a cell with the highest priority, using the PLMN with the highest priority, enables the cell with the highest priority to provide network services to the mobile device.

For example, the processor 610 implements an embodiment method of the instruction. Reference can be made to the description of relevant steps in the corresponding embodiments of FIGS. 1-2. The description is not repeated herein.

It should be noted that for the foregoing method embodiments, for simplicity, the actions are expressed as a series of action combinations. One of ordinary skill in the art should know that, the method is not limited by the action sequence described. According to the present disclosure, in the various methods, steps may be added or deleted or carried out in other orders or simultaneously. Additionally, those skilled in the art will also know that the embodiments described in the specification are only preferred embodiments. Some actions and the modules involved in the embodiments are not necessarily required by the present disclosure.

In the above embodiment, the description of each embodiment has an emphasis. Some embodiments are not described in detail, and reference can be made to the relevant description of other embodiments.

Persons of ordinary skill in the art can understand that all or parts of the steps of the various methods of the embodiments can be completed by instructing relevant hardware through a program. The program can be stored in a computer readable storage medium. The storage medium can include a flash memory disk, a read-only memory), a random access memory, a magnetic disk, or an optical disk and so on.

The network registration method, related equipment and system provided by the embodiments of the present disclosure are introduced in detail. The principle and the implementation mode of the present disclosure are set forth in the specification. The description of the embodiments of the present disclosure is only used to help understand the method of the present disclosure and the core idea thereof. Meanwhile, for a person of ordinary skill in the art, according to the idea of the present disclosure, the specific implementation mode and the application range can be changed. In conclusion, the description of the present disclosure should not be construed as limiting the present disclosure.

What is claimed is:

1. A network registration method, comprising:
reading a RPLMN recorded by a mobile device, when the mobile device is powered on, and obtaining a PLMN of a current candidate cell through network scanning;
determining whether the mobile device is initially powered on in a roaming location, according to the RPLMN recorded and the PLMN of the current candidate cell;
carrying out a network registration using the PLMN of the current candidate cell, when it is determined that the mobile device is initially powered on in a roaming location.

2. The method of claim 1, wherein, obtaining a PLMN of a current candidate cell through network scanning comprising:
acquiring a network format registered by the mobile device;
obtaining a system message of the current candidate cell by network scanning on a plurality of cells, according to the RPLMN recorded by the mobile device and the network format registered by the mobile device; and
acquiring a PLMN of the current candidate cell from the system message obtained from the network scanning.

3. The method according to claim 2, wherein, obtaining a system message of the current candidate cell by network scanning a plurality of cells, according to the RPLMN recorded by the mobile device and the network format registered by the mobile device, comprising:
acquiring a scanning frequency point preset by the mobile device;
obtaining a signal quality of each cell in plurality of cells by performing network scanning on the plurality of cells according to the preset scanning frequency point; and
selecting a cell with the best signal quality in the plurality of cells as the current candidate cell, and acquiring the system message of the current candidate cell.

4. The method of claim 1, wherein:
the RPLMN recorded by the mobile device comprising a first mobile country code;
the PLMN of the current candidate cell comprising a second mobile country code; and
determining whether the mobile device is initially powered on in a roaming location according to the RPLMN recorded and the PLMN of the current candidate cell comprising:
determining whether the first mobile country code is the same as the second mobile country code; and
determining that the mobile device is initially powered on in a roaming location if the first mobile country code is different from the second mobile country code.

5. The method according to claim 1, wherein:
the current candidate cell comprising a plurality of candidate cells;
carrying out a network registration using the PLMN of the current candidate cell when it is determined that the mobile device is initially powered on in a roaming location comprising:
acquiring a signal quality of each candidate cell in the plurality of candidate cells;
selecting a cell with the highest priority in the plurality of candidate cells according to the signal quality of each candidate cell; and
initiating a network registration request to a cell with the highest priority, using the PLMN with the highest priority, enabling the cell with the highest priority to provide network services to the mobile device.

6. A mobile device, comprising:
at least one processor; and
a storage device that stores one or more programs, which when executed by the at least one processor, cause the at least one processor to:
read a RPLMN recorded by a mobile device, when the mobile device is powered on, and obtain a PLMN of a current candidate cell through network scanning;
determine whether the mobile device is initially powered on in a roaming location, according to the RPLMN recorded and the PLMN of the current candidate cell; and
carry out a network registration using the PLMN of the current candidate cell, when it is determined that the mobile device is initially powered on in a roaming location.

7. The mobile device according to claim 6, wherein the at least one processor further to:
acquire a network format registered by the mobile device;
obtain a system message of the current candidate cell by network scanning on a plurality of cells, according to the RPLMN recorded by the mobile device and the network format registered by the mobile device; and
acquire a PLMN of the current candidate cell from the system message obtained from the network scanning.

8. The mobile device as claimed in claim 7, wherein the at least one processor further to:
acquire a scanning frequency point preset by the mobile device;
obtain a signal quality of each cell in plurality of cells by performing network scanning on the plurality of cells according to the preset scanning frequency point; and
select a cell with the best signal quality in the plurality of cells as the current candidate cell, and acquire the system message of the current candidate cell.

9. The mobile device according to claim 6, wherein:
the RPLMN recorded by the mobile device comprising a first mobile country code;
the PLMN of the current candidate cell includes a second mobile country code;
the at least one processor further to:
determine whether the first mobile country code is the same as the second mobile country code; and
a determination that the mobile device is initially powered on in a roaming location being made if the first mobile country code is different from the second mobile country code.

10. The mobile device according to claim 6, wherein:
the current candidate cell comprising a plurality of candidate cells;
the network registration module comprising:
a quality obtaining unit, configured to acquire a signal quality of each candidate cell in the plurality of candidate cells;
a cell determination unit, configured to select a cell with the highest priority in the plurality of candidate cells according to the signal quality of each candidate cell; and
a request initiation unit, configured to initiate a network registration request to a cell with the highest priority, using the PLMN with the highest priority, and enable the cell with the highest priority to provide network services to the mobile device.

11. A non-transitory storage medium having stored thereon instructions that, when executed by at least one processor of a mobile device, causes the at least one processor to perform a network registration method, the method comprising:
reading a RPLMN recorded by a mobile device, when the mobile device is powered on, and obtaining a PLMN of a current candidate cell through network scanning;
determining whether the mobile device is initially powered on in a roaming location, according to the RPLMN recorded and the PLMN of the current candidate cell;
carrying out a network registration using the PLMN of the current candidate cell, when it is determined that the mobile device is initially powered on in a roaming location.

12. The non-transitory storage medium of claim 11, wherein, obtaining a PLMN of a current candidate cell through network scanning comprising:
acquiring a network format registered by the mobile device;
obtaining a system message of the current candidate cell by network scanning on a plurality of cells, according to the RPLMN recorded by the mobile device and the network format registered by the mobile device; and
acquiring a PLMN of the current candidate cell from the system message obtained from the network scanning.

13. The non-transitory storage medium according to claim 12, wherein, obtaining a system message of the current candidate cell by network scanning a plurality of cells, according to the RPLMN recorded by the mobile device and the network format registered by the mobile device, comprising:
acquiring a scanning frequency point preset by the mobile device;
obtaining a signal quality of each cell in plurality of cells by performing network scanning on the plurality of cells according to the preset scanning frequency point; and
selecting a cell with the best signal quality in the plurality of cells as the current candidate cell, and acquiring the system message of the current candidate cell.

14. The non-transitory storage medium of claim 1, wherein:
the RPLMN recorded by the mobile device comprising a first mobile country code;
the PLMN of the current candidate cell comprising a second mobile country code; and
determining whether the mobile device is initially powered on in a roaming location according to the RPLMN recorded and the PLMN of the current candidate cell comprising:
determining whether the first mobile country code is the same as the second mobile country code; and
determining that the mobile device is initially powered on in a roaming location if the first mobile country code is different from the second mobile country code.

15. The non-transitory storage medium according to claim 11, wherein:
the current candidate cell comprising a plurality of candidate cells;
carrying out a network registration using the PLMN of the current candidate cell when it is determined that the mobile device is initially powered on in a roaming location comprising:
acquiring a signal quality of each candidate cell in the plurality of candidate cells;
selecting a cell with the highest priority in the plurality of candidate cells according to the signal quality of each candidate cell; and
initiating a network registration request to a cell with the highest priority, using the PLMN with the highest priority, enabling the cell with the highest priority to provide network services to the mobile device.
